(19) United States
(12) Patent Application Publication
(10) Pub. No.: US 2026/0336657 A1
(43) Pub. Date: Oct. 29, 2026

(54) VEHICLE AND METHOD OF CONTROLLING THE SAME

(71) Applicants: Hyundai Motor Company, Seoul (KR); Kia Corporation, Seoul (KR)

(72) Inventor: Ho Jun KIM, Hwaseong-Si (KR)

(21) Appl. No.: 19/401,734

(22) Filed: Nov. 26, 2025

(30) Foreign Application Priority Data
Apr. 29, 2025 (KR) 10-2025-0056168

(51) Int. Cl. B60W 60/00; B60W 30/12; B60W 30/18

(52) U.S. Cl. CPC B60W 60/001; B60W 30/12; B60W 30/18163; B60W 2520/06; B60W 2552/05; B60W 2552/10; B60W 2552/20; B60W 2556/40; B60W 2556/50

(57) ABSTRACT

A vehicle and a method for controlling the same are disclosed. An autonomous vehicle control device according to an example of the present disclosure comprises: a memory in which navigation data is stored; and one or more processors connected to the memory. The navigation data includes first information related to road information and second information indicating a probability of presence of a branch or merge route connected to a specific road section. The one or more processors may be configured to: divide a road included in the first information into one or more segments; assign the second information to the divided segments; generate lane-level map information based on the one or more segments to which the second information is assigned; and control traveling of an autonomous vehicle based on the generated map information.

### CROSS-REFERENCE TO RELATED APPLICATION

This application claims the benefit of priority to Korean Patent Application No. 10-2025-0056168, filed in the Korean Intellectual Property Office on April 29, 2025, the disclosure of which is incorporated herein by reference in its entirety.

### TECHNICAL FIELD

Various examples of the present disclosure relate to an autonomous vehicle and a method of controlling the autonomous vehicle.

### BACKGROUND

The matters described in this Background section are only for enhancement of understanding of the background of the disclosure, and should not be taken as acknowledgment that they correspond to prior art already known to those skilled in the art.

In order to efficiently travel to destinations, autonomous vehicles require a technology for accurately identifying road lane information and determining the need for lane changes in merging and branching sections.

However, using navigation information, a vehicle may receive road shape or lane count information and may provide simple guidance to a driver.

However, the conventional technologies fail to reflect lane-to-lane connectivity information in the merging or branching section, making it difficult to determine accurate lane changes to reach the destination.

### SUMMARY

The present disclosure is directed to generating road shape and lane-to-lane connectivity information using navigation information and determining a driving lane and whether a lane change is necessary based on the generated information.

Objects of the present disclosure are not limited to the above objects, and other objects that are not described will be able to be clearly understood by those skilled in the art based on the following description.

According to the present disclosure, an apparatus of a vehicle may comprise a memory configured to store navigation data associated with the vehicle, wherein the navigation data may comprise first information related to road information of a road on which the vehicle is traveling, and second information indicating a probability of presence of a branch route or a merge route, wherein the branch route or the merge route is connected to a specific road section of the road.

The apparatus may further comprise a processor circuit coupled to the memory and configured to divide, based on the first information, the road into a plurality of segments; assign the second information to the divided plurality of segments; output, based on the assignment of the second information, a signal indicating lane-level map information; and control, based on the signal, autonomous driving of the vehicle. The processor circuit may be configured to determine, based on the lane-level map information, lane-to-lane connectivity, and based on the determined lane-to-lane connectivity, perform at least one of providing traveling information or controlling autonomous driving of the vehicle.

The processor circuit may be configured to divide, based on an entry point included in the first information or an exit point included in the first information, the road into the plurality of segments. The first information may comprise at least one of a road shape of the road, a number of lanes on the road, an entry point of the road, or an exit point of the road. The processor circuit may be configured to, based on the probability of presence of the branch route or the merge route and a position of a route corresponding to the second information relative to a main lane of the road, generate the lane-level map information.

The processor circuit may be configured to determine, based on the probability of presence of the branch route or the merge route and a positional relationship between a main lane of the road and one of the branch route or the merge route, a number of lanes to be included in the lane-level map information. The processor circuit may be configured to assign the second information to the divided plurality of segments based on the probability of presence of the branch route or the merge route being less than a preset first reference value, and not assign the second information to the divided plurality of segments based on the probability of presence of the branch route or the merge route being greater than or equal to the preset first reference value.

The processor circuit may be configured to determine that a route corresponding to the second information is the merge route based on the probability of presence of the branch route or the merge route being less than a second reference value that is less than the preset first reference value, and determine that the route corresponding to the second information is the branch route based on the probability of presence of the branch route or the merge route being greater than or equal to the second reference value. The processor circuit may be configured to generate road-level information based on a current position and traveling direction of the vehicle in the plurality of segments of the road, and generate, based on the road-level information, the lane-level map information. The processor circuit may be configured to display the lane-level map information on a display of the vehicle.

According to the present disclosure, a method may be performed by an apparatus of a vehicle. The method may comprise receiving, via a communication interface of the vehicle, navigation data comprising first information related to road information of a road on which the vehicle is traveling, and second information indicating a probability of presence of a branch route or a merge route, wherein the branch route or the merge route is connected to a specific road section of the road. The method may further comprise dividing, based on the first information, the road into a plurality of segments; assigning the second information to the divided plurality of segments; outputting, based on the assignment of the second information, a signal indicating lane-level map information; and controlling, based on the signal, autonomous driving of the vehicle.

According to the present disclosure, a vehicle may comprise a sensor configured to provide a current position and heading of the vehicle; a communication interface configured to receive navigation data comprising a first part indicating a structure of a road on which the vehicle is traveling, and a second part indicating a probability of presence of a branch route or a merge route, wherein the branch route or the merge route is connected to a specific road section of the road; a driving control circuit configured to control autonomous driving of the vehicle; and a processor circuit configured to generate, based on the current position and heading of the vehicle, road-level coordinates in a coordinate frame relative to the vehicle; divide, based on the road-level coordinates and the first part of the navigation data, the road into a plurality of segments; classify, based on the second part of the navigation data, for each segment of the plurality of segments, whether a corresponding route is a main lane of the road, the branch route, or the merge route; output, based on the classification, a signal indicating lane-to-lane connectivity between adjacent segments of the plurality of segments; and control, via the driving control circuit and based on the signal, autonomous driving of the vehicle.

The processor circuit may be further configured to determine, based on the signal, whether a lane change is required to reach a destination, and based on the determination of whether the lane change is required, cause the vehicle to maintain or change a lane. The processor circuit may be configured to perform the classification by comparing the probability of presence of the branch route or the merge route with at least one reference threshold. The first part of the navigation data may comprise at least one of an entry point of the road, an exit point of the road, or a number of lanes on the road.

### BRIEF DESCRIPTION OF THE DRAWINGS

The above and other objects, features and advantages of the present disclosure will become more apparent to those of ordinary skill in the art by describing examples thereof in detail with reference to the accompanying drawings, in which:

FIG. 1 is an exemplary configuration diagram of an autonomous vehicle;

FIG. 2 is an exemplary flowchart for describing the generation of a map using navigation information;

FIG. 3 is an exemplary flowchart for describing the generation of the map using the navigation information in detail;

FIG. 4 shows an example of a road divided into units of segments;

FIG. 5 shows an example of the generation of lane-level information; and

FIG. 6 shows an example computing system.

### DETAILED DESCRIPTION

Hereinafter, preferred examples of the present disclosure will be described in detail with reference to the accompanying drawings.

However, the technical spirit of the present disclosure is not limited to some of the examples described herein but may be implemented in various different forms. Within the scope of the technical spirit of the present disclosure, one or more of the constituent elements may be selectively combined or substituted between examples.

In addition, the terms (including technical and scientific terms) used in the examples of the present disclosure, unless explicitly defined and described otherwise, may be interpreted as having a meaning that may be generally understood by a person having ordinary skill in the art to which the present disclosure pertains. Commonly used terms, such as those defined in dictionaries, should be interpreted in consideration of their contextual meaning in the relevant art.

Furthermore, the terms used in the examples of the present disclosure are for the purpose of describing the examples and are not intended to limit the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B. In describing the components of the examples of the present disclosure, terms such as first, second, A, B, (a), (b), etc., may be used. These terms are only for distinguishing one component from another, and the essence, order, or sequence of the corresponding component is not limited by these terms.

When a component is described as being 'connected,' 'coupled,' or 'joined' to another component, it may include not only cases where it is directly connected, coupled, or joined to the other component, but also cases where it is 'connected,' 'coupled,' or 'joined' through yet another component between them.

Furthermore, when a component is described as being formed or disposed "on (top of)" or "under (below)" another component, "on" or "under" includes not only cases where the two components are in direct contact with each other but also cases where one or more other components are formed or disposed between the two components. In addition, when expressed as "on (top of)" or "under (below)," it may include the meaning of not only the upward direction but also the downward direction with respect to one component.

In the various flowcharts of this document, at least some of the steps may be omitted or their mutual order may be changed, and at least some of the various examples of this document may be performed at a specific point in time of each step of the flowcharts. The operations of the various flowcharts in this document may be performed by at least one of the control device 100, the processor 130, and the autonomous vehicle 10. In addition, redundant content in the drawings of this document may be omitted. In this document, the 'control device 100' may also be referred to as the 'autonomous vehicle control device 100'.

'Driver control assistance system' as referred to in this document means hardware and software that may assist a driver in continuously controlling the longitudinal and lateral movements of a vehicle. Such a driver control assistance system may be referred to as an 'autonomous driving system' or 'system' in this document.

'Feature' as referred to in this document may mean a specific function of a system that aids a driver in defined traffic scenarios, situations, and system boundaries.

'Dynamic Control' as referred to in this document may mean performing the operational and tactical functions necessary to move the vehicle in real time. This may include control of the vehicle's lateral and longitudinal movements, monitoring of the road environment, responding to events in the road traffic environment, operational planning, and signaling.

'System Boundaries' as referred to in this document may mean verifiable or measurable limits or conditions set by the manufacturer, up to or within the conditions that affect the system or the function of the system designed to aid the driver and the ability of the system to operate as intended.

Each step of the flowcharts mentioned in this document may be described as being performed by the processor 130 of the autonomous vehicle 10, but is not limited thereto, and the control device 100 or the autonomous vehicle 10 itself may perform the examples of each step.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor may read information from a memory and/or record the information in the memory, the memory may be in a state of electronic communication with a processor. Memory integrated into a processor is in a state of electronic communication with the processor

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, or road-segment-specific control logic derived from lane connectivity data). Based on one or more features (e.g., feature of segment-based lane connectivity determination using navigation-derived data) described herein, an operation of the vehicle may be controlled.

Specifically, the autonomous driving control apparatus may dynamically adjust the driving behavior of the vehicle—such as acceleration, deceleration, or steering control—based on the lane connectivity or branch/merge probabilities of upcoming road segments. For example, when navigation-derived data indicates that a next segment includes multiple merging lanes, the autonomous driving system may lower the autonomous driving level, reduce speed, and activate a higher vigilance mode for collision avoidance. Conversely, when the upcoming segment exhibits continuous and stable lane connectivity with no nearby branch routes, the autonomous driving level may be increased to enable smoother lane centering and steady-speed cruise control.

In another example, when the connectivity data shows that a left branch route appears within a threshold distance (e.g., 200 meters), the autonomous driving system may proactively prepare for a possible lane change by adjusting the steering angle range and acceleration change rate control parameters. Similarly, when a merge route is detected on the right side of the next segment, the vehicle control may bias acceleration and lateral control to maintain a safer distance from merging traffic.

The vehicle control may include various operational controls associated with the vehicle (e.g., autonomous driving control, sensor control, braking control, braking time control, acceleration control, acceleration change rate control, alarm timing control, forward collision warning time control, or lateral stability control) that are adaptively managed according to the segment-based lane connectivity information. Through such control, the autonomous driving apparatus may dynamically tune driving performance for each segment—enhancing safety, smoothness, and responsiveness under varying road geometries.

One or more auxiliary devices (e.g., engine brake, exhaust brake, hydraulic retarder, electric retarder, regenerative brake, or similar braking-assist systems) may also be controlled, for example, based on one or more features (e.g., feature of segment-based lane connectivity determination using navigation-derived data) described herein.

Specifically, when the processor determines from navigation-derived lane connectivity data that an upcoming segment includes a merge route or a sharp curvature requiring speed reduction, the control system may activate one or more auxiliary braking devices (e.g., engine brake or electric retarder) in advance to decelerate the vehicle smoothly. Conversely, when the next segment is determined to be a straight and continuous lane with stable connectivity, the system may reduce auxiliary braking and prioritize regenerative braking to enhance energy recovery efficiency.

For example, if the lane connectivity data indicates that the vehicle is approaching a downhill segment followed by a merging area, the engine brake and hydraulic retarder may be jointly controlled to maintain a safe deceleration rate while preventing brake overheating. In another example, when the system detects that the next few connected segments include frequent branching points or exit ramps, the regenerative braking may be temporarily limited to maintain sufficient torque responsiveness for potential lateral maneuvers. Similarly, when the navigation-derived data confirms a long, uninterrupted segment without merge or branch routes, the regenerative brake may be emphasized to maximize energy recovery during steady-state cruising.

Through such adaptive control, the auxiliary braking devices may cooperate with the main driving control system to enhance vehicle stability, safety, and energy efficiency according to segment-specific lane connectivity conditions.

One or more communication devices (e.g., a modem, a network adapter, a radio transceiver, an antenna, etc., that are capable of communicating via one or more wired or wireless communication protocols such as Ethernet, Wi-Fi, near-field communication (NFC), Bluetooth, Long-Term Evolution (LTE), 5G New Radio (NR), or vehicle-to-everything (V2X)) may also be controlled, for example, based on one or more features (e.g., feature of segment-based lane connectivity determination using navigation-derived data) described herein.

Specifically, when the processor determines that an upcoming road segment includes a merge or branch route based on navigation-derived connectivity data, the communication device may adjust its communication priority or channel usage to exchange real-time information with external entities (e.g., nearby vehicles or infrastructure) that are relevant to that lane condition. For example, when the vehicle approaches a segment with a high probability of merging traffic, the V2X transceiver may increase the transmission rate or switch to a low-latency communication mode to receive lane-specific warnings or speed-adjustment messages from nearby vehicles. Conversely, when the navigation-derived data indicates that the vehicle is entering a long, uninterrupted segment with stable lane connectivity, the communication module may lower the communication frequency or prioritize data related to route planning and cloud updates rather than immediate collision-avoidance exchanges.

In another example, when the connectivity determination identifies a branch route leading to a service area or deceleration lane, the communication unit may initiate a connection with a roadside unit (RSU) or infrastructure node to obtain local traffic density, parking availability, or roadwork updates specific to that segment. Similarly, when the vehicle enters a multi-merge intersection zone, the system may synchronize V2X communication timing across multiple antennas to enhance positional accuracy and prevent packet collision under dense-traffic conditions.

Through such adaptive control, the communication devices may optimize data exchange for safety and efficiency—intensifying communication during high-risk or dynamic segments and conserving bandwidth during stable driving sections.

Minimum risk maneuver (MRM) operation(s) may also be controlled, for example, based on one or more features (e.g., feature of segment-based lane connectivity determination using navigation-derived data) described herein. A minimal risk maneuvering operation may utilize lane connectivity information determined from navigation-derived data to identify the safest available segment or lane for performing a risk-reducing maneuver when an emergency condition or driver non-responsiveness is detected.

Specifically, when the processor determines that the vehicle is currently in a segment with stable lane connectivity (e.g., continuous lanes without merges or branches), the MRM control may guide the vehicle to decelerate and stop within the current lane. Conversely, when navigation-derived data indicates that the current segment includes complex lane connectivity (e.g., a branch or merge zone ahead), the MRM system may select an alternate segment—such as a branch route with lower traffic probability or an emergency shoulder area—based on the lane connectivity relationships between adjacent segments.

For example, when the lane connectivity data shows that the vehicle is approaching a right-side merge area within 100 meters, the processor may preemptively control steering to maintain a bias toward the center of the lane to avoid collision risks from merging vehicles during the MRM event. Alternatively, when the vehicle is in a segment where a left-side branch route leads to a service area or deceleration lane, the processor may determine that entering the branch route represents a lower-risk maneuver and autonomously guide the vehicle along that path for a controlled stop.

A minimal risk maneuver may be an operation that may be activated during autonomous driving of the vehicle when a driver is unable to respond to a request to intervene. During the minimal risk maneuver, one or more processors of the vehicle may control the driving operation (e.g., braking, steering, and lane selection) based on segment-level lane connectivity and probability data to ensure the vehicle moves to a predicted safe zone while minimizing potential interactions with other vehicles.

For instance, when the navigation-derived data indicates that downstream segments include multiple merge lanes with high traffic probability, the MRM system may execute a controlled deceleration and halt in the current lane. However, if the data indicates a clear side segment with low connectivity to the main flow (e.g., an emergency shoulder or exit ramp), the system may perform a lateral transition into that segment before stopping.

Biased driving operation(s) may also be controlled, for example, based on one or more features (e.g., feature of segment-based lane connectivity determination using navigation-derived data) described herein. A driving control apparatus may perform biased driving control by adjusting the vehicle’s lateral position within a lane based on the lane connectivity or the probability of nearby branch or merge routes determined from navigation-derived data.

Specifically, when the processor determines that a current road segment includes a merge route on one side (e.g., right-side merge with high stub probability), the vehicle may be biased toward the opposite side (e.g., the left portion of the lane) to maintain a safer distance from merging traffic. Conversely, when the next segment includes a branch route on the left side, the vehicle may be biased toward the right portion of the lane to facilitate smoother lane continuation and minimize unnecessary lateral movement before the branch point.

For example, if the navigation-derived data indicates that the upcoming segment involves multiple merge routes on the right within 100 meters, the driving control apparatus may gradually offset the vehicle’s position by a predetermined lateral distance (e.g., 20–40 cm) toward the left side of the lane. This adjustment may improve driving stability and reduce the risk of sudden lateral corrections near merge points. Similarly, when the lane connectivity data indicates that the next few segments include no branching or merging lanes, the driving control system may maintain the vehicle at the lane center for smoother, energy-efficient cruising.

The driving control apparatus may identify or determine a biased target lateral distance for such biased driving control based on segment-specific lane geometry and connectivity attributes. For instance, the system may dynamically modify the lateral target depending on the lane width, curvature, or predicted merging vehicle trajectory extracted from navigation-derived data. This adjustment may be made to improve the vehicle's stability, safety, and/or performance under varying driving conditions (e.g., maintaining clearance from merging vehicles, avoiding roadside obstacles, or aligning better for upcoming lane transitions, etc.).

For example, during a lane change in a multi-segment transition zone, the driving control apparatus may bias the lateral distance to secure an optimal position relative to an adjacent lane, considering the lane connectivity probabilities of upcoming segments and the current road curvature.

One or more sensors (e.g., IMU sensors, cameras, LIDAR, RADAR, blind-spot monitoring sensors, line departure warning sensors, parking sensors, light sensors, rain sensors, traction control sensors, anti-lock braking system sensors, tire pressure monitoring sensors, seatbelt sensors, airbag sensors, fuel sensors, emission sensors, throttle position sensors, inverters, converters, motor controllers, power distribution units, high-voltage wiring and connectors, auxiliary power modules, charging interfaces, etc.) may also be controlled, for example, based on one or more features (e.g., feature of segment-based lane connectivity determination using navigation-derived data) described herein.

Specifically, when the processor determines, based on navigation-derived data, that a current road segment includes complex lane structures such as multiple merge or branch routes, the control device may increase the sampling rate or activation frequency of environment-recognition sensors (e.g., LIDAR, front cameras, or side RADAR) to improve object detection around merging areas. Conversely, when the lane connectivity in the current segment is stable and unambiguous (e.g., a straight expressway segment without nearby branch lanes), the system may reduce redundant sensor polling or deactivate certain short-range sensors to save power.

For example, when the segment-based lane connectivity analysis indicates a potential merge event on the right side of the road, the processor may activate or widen the detection range of the right-side RADAR and blind-spot monitoring sensors to monitor incoming vehicles. Similarly, when the system detects that the upcoming segment involves a left-side branch route with high stub probability, the left-side LIDAR and camera may be prioritized for lane-edge detection and merging-gap estimation. In addition, when navigation-derived data confirms that only one travelable lane continues through consecutive segments, the sensor control unit may reduce the frequency of lane-boundary image updates or switch certain sensors to a low-power mode.

An autonomous driving level and/or autonomous driving activation/deactivation may also be controlled, for example, based on one or more features (e.g., feature of segment-based lane connectivity determination using navigation-derived data) described herein. A driving control apparatus may adjust an autonomous driving mode or temporarily deactivate autonomous driving depending on how stable or predictable the lane connectivity is within a current road segment. For example, when the processor determines, based on navigation-derived data, that a current segment includes complex lane branching, merging, or unclear connectivity (e.g., near highway exits, intersections, or construction zones), the autonomous driving level may be lowered to require greater driver attentiveness. Conversely, when the lane connectivity of the current segment is stable and unambiguous (e.g., a straight multi-lane highway with no merging or branching lanes detected), the autonomous driving level may be raised to allow higher autonomy.

In one example, if the navigation-derived data indicates a probability of multiple merge routes ahead in the next segment, the driving control apparatus may issue a transition request to the driver or deactivate lane-keeping assist until the vehicle passes the merging zone. In another example, if segment-based lane connectivity analysis confirms that only one travelable lane continues for the next few segments, the apparatus may automatically re-activate full autonomous driving mode for continuous cruising.

By dynamically controlling the autonomous driving level based on such segment-specific connectivity information, the system may balance safety and driver convenience—tightening driver engagement in complex environments and relaxing it in predictable lane structures.

According to the present disclosure, a vehicle control technology is provided that enables an autonomous vehicle to determine, with improved accuracy, a driving lane and a need for lane change in road environments including merging or branching sections. The vehicle may include a control apparatus configured to generate lane-level map information based on navigation data and to control vehicle traveling based on the generated map. The control apparatus may divide a road into a plurality of segments using navigation data that includes first information related to a road structure and second information indicating a probability of the presence of a branch or merge route (stub). By comparing the probability values associated with each stub, the control apparatus may distinguish between main lanes, branch routes, and merge routes, and assign such information to the corresponding segments. The control apparatus may then generate lane-level map information representing the number, order, and positional relationships of lanes within each segment and estimate lane-to-lane connectivity across adjacent segments. Based on the estimated connectivity, the control apparatus may determine an optimal target lane required for the vehicle to reach a destination, determine whether a lane change is necessary, and output a control command or display information to guide or control lane change operations. Through such configuration, the autonomous vehicle may generate a detailed local map reflecting lane-to-lane connectivity information using navigation data, thereby enabling efficient lane-level route planning and stable traveling control in complex road environments.

Hereinafter, examples will be described in detail with reference to the accompanying drawings, but the same reference numerals will be assigned to the same or corresponding components regardless of the drawing numbers, and redundant descriptions thereof will be omitted.

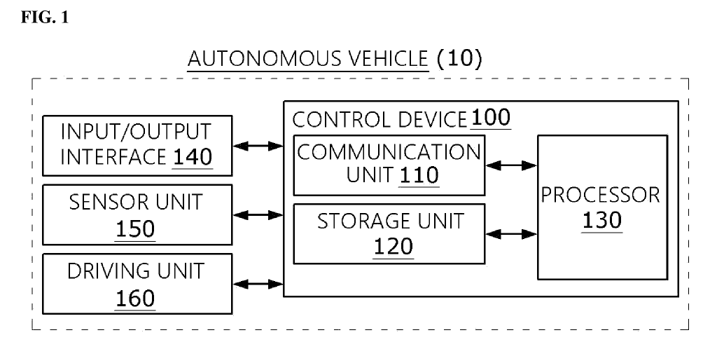

FIG. 1 is an exemplary configuration diagram of an autonomous vehicle 10 according to an example.

The autonomous vehicle 10 may include a control device 100, a communication unit 110, a storage unit 120, a processor 130, an input/output interface 140, a sensor unit 150, and a driving unit 160. Each of these components in FIG. 1 may be implemented inside the vehicle.

The autonomous vehicle 10 may be dynamically controlled in various driving situations through an autonomous driving system. For example, the autonomous driving system may provide both driving stability and convenience through longitudinal control (acceleration and deceleration) and lateral control (lane keeping and changing) of the autonomous vehicle 10 (e.g., highway cruising, traffic-jam assist, automatic parking, or obstacle avoidance, etc.). This autonomous driving system may monitor the driving environment through sensors and a control device, and process data in real time to adjust the vehicle's position, driving speed, direction, and the like.

The control device 100 may be formed integrally with the internal components of the vehicle, or it may be implemented as a separate, independent device that communicates with the internal vehicle components through various connection means (e.g., MAY bus, wireless network, wired Ethernet connection, etc.). The control device 100 includes the communication unit 110, the storage unit 120, and the processor 130 to manage the longitudinal and lateral control of the vehicle, and may additionally include other components such as the input/output interface 140, the sensor unit 150, and the driving unit 160 to perform complex control functions according to the driving situation (e.g., adaptive cruise, automatic braking, or lane-change assist, etc.).

The control device 100 may control the safety and convenience functions of the vehicle by storing data collected from the sensor unit 150 during driving in the storage unit 120 and processing it in real time. For example, the control device may perform overall control and management of the autonomous driving system, such as providing notifications in situations requiring driver intervention based on data detected from the sensor unit 150 (e.g., sudden obstacle detection, driver inattention, or poor weather conditions, etc.).

The control device 100 may display the vehicle control status or receive driver input to control driving functions through a user interface linked with an HMI (Human-Machine Interface) based on various driver settings and driving conditions (e.g., touchscreen commands, voice prompts, or steering-wheel controls, etc.).

According to an example of the present disclosure, the control device 100 may generate lane-level map information about the vehicle's surrounding environment by dividing a road into a plurality of segments using navigation data stored in the storage unit 120 and assigning a corresponding branch or merge route to each segment (e.g., highway exit, service-road entry, or merging ramp, etc.). Furthermore, the control device 100 may determine lane-to-lane connectivity using the generated lane-level map information and, based on the determination result, provide driving information for the vehicle or control the driving of the autonomous vehicle 10.

The communication unit 110 performs communication with other control devices inside the vehicle to share data between systems, or transmits and receives various information through a connection with the outside of the vehicle. The communication unit 110 uses various in-vehicle communication methods such as MAY communication and Ethernet to transmit control signals and data between internal components, and may interlink driving information and external data in real time through communication with a user terminal, other vehicles (V2V: Vehicle-to-Vehicle), infrastructure (V2I: Vehicle-to-Infrastructure), or an external server (e.g., a cloud-based navigation server or traffic-management center, etc.).

The communication unit 110 may perform functions for short-range communication, a GNSS (Global Navigation Satellite System) module (e.g., GPS module), V2X (Vehicle-to-Everything) communication, optical communication, broadcast transmission/reception, and ITS (Intelligent Transport Systems) communication. For example, the communication unit 110 may support stable data transmission at close range using various wireless communication technologies such as Bluetooth, RFID (Radio Frequency Identification), IrDA (Infrared Data Association), UWB (Ultra Wideband), ZigBee, NFC (Near Field Communication), Wi-Fi, Wi-Fi Direct, and Wireless USB (e.g., for keyless entry, sensor synchronization, or OTA updates, etc.). Additionally, it may perform long-distance communication through mobile communication modules based on mobile networks such as LTE and 5G and wireless internet modules to receive real-time data or link with the cloud (e.g., for map updates, fleet data sharing, or emergency reporting, etc.), thereby improving the performance of the autonomous driving system.

According to an example of the present disclosure, the communication unit 110 may receive navigation data including road shape information, lane count information, and probability information of the presence of a branch or merge route (stub) from a navigation server or external infrastructure (e.g., roadside units, cloud map servers, or smart traffic signals, etc.).

The storage unit 120 may include various types of memory capable of storing data and may be integrated inside the control device 100 or the processor 130 or configured as a separate module. The storage unit 120 may include non-volatile memory and volatile memory (e.g., flash memory, SSD, DRAM, or SRAM, etc.), and may implement a memory system of various capacities and performance by combining them.

According to an example, the storage unit 120 may include a memory that may store and manage various data related to the autonomous driving system (e.g., sensor logs, driving history, or map cache, etc.).

According to an example of the present disclosure, the storage unit 120 may store and manage navigation data including road information such as road shape, lane count, and entry or exit points, as well as the probability of the presence of a branch or merge route (e.g., probability of a merging ramp, side road, or bifurcation, etc.).

The processor 130 communicates with the communication unit 110, the storage unit 120, the input/output interface 140, the sensor unit 150, the driving unit 160, and various internal components of the autonomous vehicle 10 through electrical or operational connections, and controls the operation of each component and performs data processing. The processor 130, as a central processing unit for executing instructions and calculating data, may perform vehicle control by collecting, processing, and analyzing data in real time according to the vehicle's driving environment (e.g., traffic density, road curvature, or weather changes, etc.).

The processor 130 may be implemented in the form of hardware, software, or a combination thereof, and for example, may perform vehicle control logic in the form of a microcontroller, FPGA, or ASIC (e.g., NVIDIA DRIVE chip, Renesas MCU, or Xilinx FPGA, etc.). Furthermore, it may include a multi-processor configuration to control complex autonomous driving and driver assistance systems (e.g., perception, path planning, and control threads running in parallel, etc.). This processor configuration may support comprehensive vehicle control and stable performance through the execution of autonomous driving and assistance systems, sensor data processing, communication data management, and driving-related decision-making functions.

According to an example of the present disclosure, the processor 130 may divide a road into segments based on navigation data stored in the storage unit 120, generate lane-level map information, use this to determine lane connectivity, and provide driving information or generate vehicle control signals to control the autonomous vehicle 10 (e.g., for lane-selection, merging control, or exit guidance, etc.).

The input/output interface 140 serves to receive input related to vehicle control from a user and to deliver the control status of the vehicle and system operation information to the user.

The input/output interface 140 may perform the function of receiving various inputs from a user and delivering the vehicle control status to the user. For example, the input/output interface 140 may include at least one of input via physical buttons provided inside the autonomous vehicle 10, input via soft buttons displayed on the display of the autonomous vehicle 10, user voice input, and user gesture input (e.g., touch gestures, speech commands, or hand-wave recognition, etc.).

The input means may include physical buttons, soft keys on a touch display, a voice recognition function, a gesture recognition function, and the like, through which a user may input commands such as requests to activate the autonomous driving system, switch functions, or set driving assistance (e.g., following distance, cruise speed, or preferred lane, etc.).

In addition, the input means may receive user input through an input device provided on the steering wheel of the autonomous vehicle 10. For example, through buttons mounted on the steering wheel, the driver may input commands to activate or deactivate the autonomous driving system even while driving. Such steering wheel-based input may support the user in quickly controlling autonomous driving functions by providing an intuitive interface (e.g., left-thumb button for lane change, right-thumb switch for cruise speed, etc.).

The output means includes a display, an audio module (e.g., speaker), a haptic module, and the like, and may provide the status of the autonomous driving system, control transition request notifications, function activation status, etc., to the user in visual, audible, and tactile forms (e.g., dashboard alert, seat vibration, or audible chime, etc.).

In addition, the status of the autonomous driving system may be intuitively checked through a head-up display (HUD), a cluster, an AVN (Audio Video Navigation), and displays built into the rearview mirror or side mirrors (e.g., for navigation prompts, blind-spot warnings, or driver alerts, etc.). Besides these, the status of the autonomous driving system may also be checked through the display of a console installed in each row of the autonomous vehicle 10, an application on a user terminal, and the like (e.g., smartphone app, tablet interface, or smartwatch display, etc.).

The sensor unit 150 may include a number of sensors that detect various driving and environmental information in real time to support the stable operation of the autonomous driving system. The sensor unit 150 may measure the distance to and speed of surrounding objects through long-range detection sensors such as RADAR (Radio Detection and Ranging) and LIDAR (Light Detection and Ranging), and may include ultrasonic sensors to detect objects near the autonomous vehicle 10 (e.g., for parking, low-speed maneuvers, or obstacle detection, etc.).

Furthermore, the sensor unit 150 includes position sensors such as GPS to collect position information of the autonomous vehicle 10, and includes light sensors to provide information on ambient brightness so that the system may respond to changes in light (e.g., sunrise, tunnels, or street lighting, etc.). In addition, the sensor unit 150 may include accelerator and decelerator pedal sensors, a steering wheel detection sensor, a seating sensor, and the like to monitor the driving control state of the autonomous vehicle 10 and user actions (e.g., pedal pressure, steering angle, or seat occupancy, etc.).

The sensor unit 150 may include a camera. The camera may be classified into an external camera and an internal camera. The external camera recognizes the road and surrounding environment, and the internal camera may comprehensively grasp the situation inside and outside the vehicle by detecting the driver's state (e.g., eye tracking, drowsiness detection, or facial expression analysis, etc.) or the indoor situation (e.g., passenger presence, seatbelt usage, or gesture command, etc.).

The sensor unit 150 may include a heart rate sensor, a pressure sensor, an infrared sensor, and the like to collect the driver's biometric information or various environmental data (e.g., cabin temperature, air quality, or driver stress level, etc.).

The driving unit 160 provides the driving force necessary for the travel of the autonomous vehicle 10 and may include various components that control the vehicle's operation according to commands output from the control device 100. The driving unit 160 may be composed of devices that generate and transmit the vehicle's power, such as an engine, motor, transmission, and wheel drive system, and a controller that controls them (e.g., inverter, ECU, or motor driver, etc.). Through these components, the acceleration, deceleration, and direction change of the autonomous vehicle 10 may be performed.

The driving unit 160 may be controlled to maintain driving safety by performing longitudinal control (acceleration and deceleration) and lateral control (lane keeping and changing) of the vehicle (e.g., curve entry, overtaking, or highway merging, etc.). For example, it adjusts the motor's output or the rotational speed and direction of the wheels in response to commands from the control device 100, allowing the vehicle to follow the driving path.

In addition, the driving unit 160 includes a brake system to reduce the vehicle's speed or stop it during driving (e.g., regenerative braking, hydraulic braking, or emergency braking, etc.). The driving unit 160 may control the autonomous vehicle 10 through an electric motor in the case of an electric vehicle, or based on engine output in the case of an internal combustion engine vehicle (e.g., hybrid, plug-in hybrid, or fuel-cell system, etc.).

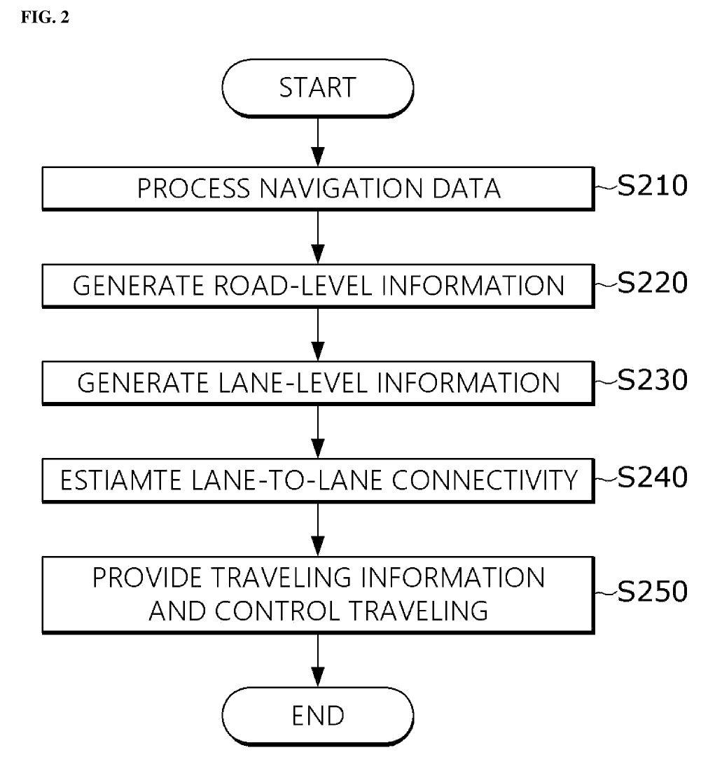

FIG. 2 is an exemplary flowchart for describing the generation of a map using navigation information according to an example of the present disclosure.

The processor 130 may process navigation data stored in the storage unit 120 (S210).

Specifically, the navigation data may include first information indicating the structural characteristics of a road and second information indicating the probability indicated by the presence of a branch or merge route (stub) connected to a specific road section (e.g., highway exit, side road, ramp, or merging lane, etc.).

The first information represents the overall shape and structure of the road on which the autonomous vehicle 10 will travel and may include, for example, a road shape, the number of lanes, locations of entry and exit points, , or road curvature, slope, and surface type, etc. The road shape information may be composed of the coordinates of multiple points forming a road, and the actual shape of the road may be represented by sequentially connecting the coordinates of each point (e.g., centerline coordinates, lane boundaries, or shoulder points, etc.). In addition, lane count information may refer to the number of lanes on which a vehicle may travel in a specific road section, and such information may serve as the basis for generating accurate lane-level information in subsequent operations (e.g., determining lane width, lane-change feasibility, or merge-point prediction, etc.).

The second information represents, in a probability form in a specific section of the road, the likelihood that the autonomous vehicle 10 will travel or the road is branched off or merged and may be typically represented as “stub probability information.” The stub probability information may be represented by a value between 0% and 100%, which may represent whether a specific stub route is a drivable road route and the likelihood that a vehicle will travel along the route (e.g., 0% for blocked or dead-end routes, 50% for optional merges, or 100% for major connecting lanes, etc.).

For example, when the stub probability information has a very low value (e.g., close to 0%), the stub may be a road on which a vehicle cannot travel or a merge-only lane that is unlikely to be used by vehicles (e.g., restricted access lane, shoulder connection, or maintenance road, etc.). On the other hand, when the stub probability exceeds a predetermined reference value, it may be determined that the stub is a branch route that may be used as an actual driving route (e.g., exit ramp, service road, or feeder lane, etc.). According to an example of the present disclosure, whether to assign a stub route that connects to a road segment may be determined based on such stub probability information in subsequent operations.

For example, the processor 130 of the autonomous vehicle 10 may receive navigation data including the probability (e.g., 0%, 30%, 70%, or the like) of the presence of a stub route together with navigation data including a road shape, the number of lanes, entry/exit points, and the like from the storage unit 120 (e.g., map database, onboard cache, or cloud source, etc.) and analyze the navigation data to prepare data for subsequent processing. Based on the analyzed navigation data, the processor 130 may structure or organize and process the data to generate road-level and lane-level information in subsequent operations (e.g., generating connectivity maps, merging rules, or vehicle path models, etc.).

In addition, the processor 130 may receive navigation data in real time from an external server or cloud via the communication unit 110 and store the navigation data in the storage unit 120, thereby updating data to be used in subsequent processing operations (e.g., dynamic traffic data, accident alerts, or construction-zone updates, etc.).

To this end, the processor 130 may be configured to update the navigation data periodically or in real time or receive and update the navigation data only when the autonomous vehicle 10 enters a specific traveling area (e.g., a new city, highway section, or geofenced zone, etc.). Accordingly, the processor 130 may perform subsequent processing based on the latest road information.

The processor 130 may generate road-level information based on the navigation data processed in operation S210 of processing the navigation data (S220).

Specifically, the processor 130 may divide the entire or at least a portion of the road into one or more segments based on the road information (first information) included in the navigation data. Here, the segment is a logical unit for managing the road on which the autonomous vehicle 10 travels and may be classified based on a specific entry point, exit point, or the like of the road (e.g., intersection, interchange, or ramp connection, etc.). The segment may be referred to as, for example, a “road section.”

Specifically, the processor 130 may divide the road into multiple segments using entry points or exit points. For example, a road section extending from a specific entry point to the next exit point may be defined as a segment (e.g., between two consecutive highway exits or between merging and diverging points, etc.).

In addition, the processor 130 may separate segments based on points at which the road shape changes significantly or the number of lanes changes (e.g., lane drop, curve radius change, or slope variation, etc.). The processor 130 may use such segment-based road-level information to generate more specific lane-level information in subsequent operations (e.g., lane alignment maps, connectivity matrices, or lane-change planning data, etc.).

Specifically, the processor 130 may generate road-level coordinates based on a current position and heading of the autonomous vehicle 10 (e.g., derived from GPS, inertial sensors, or LiDAR localization, etc.). The road-level coordinates may be represented as a coordinate system represented relatively using the position of the autonomous vehicle 10 as a reference point for a specific segment. The relative coordinate system may be used to determine the accurate position of the vehicle on the road and plan subsequent driving routes (e.g., determining lane centerlines, offset corrections, or curve alignment, etc.). For example, the processor 130 may set the current position of the vehicle as a reference point and then generate the shape of a road segment within a predetermined distance from the corresponding position in the form of relative coordinates (e.g., within 100 m, 200 m, or 500 m ahead, etc.).

In addition, the processor 130 may determine the total number of travelable lanes for each segment. Specifically, the processor 130 may determine the total number of lanes included in each segment using lane count information and information on lane count changes at entry or exit points, which are provided from the navigation data (e.g., lane merges, splits, or auxiliary lane additions, etc.).

Through operation S220 of generating road-level information, the processor 130 may prepare road-level information for each segment and, based on this information, may provide relevant information in operation S230 of generating lane-level information and operation S240 of estimating lane-to-lane connectivity, which are subsequent operations (e.g., hierarchical processing of road data, feature extraction, or lane-network construction, etc.).

The processor 130 may generate lane-level information based on the road-level information (S230).

Specifically, the processor 130 may generate specific information on each lane by combining the total number of lanes in each segment included in the road-level information with the stub probability and stub positional relationship in the navigation data (e.g., identifying merging lanes, diverging lanes, or auxiliary ramps, etc.). In this case, the stub positional relationship may refer to whether the stub is present at a left or right side of the driving lane.

The processor 130 may use the stub probability and positional relationship to determine whether the stub is a merging or branch route and determine the number of lanes and the lane connection order based on the determination result (e.g., main-to-ramp connection, ramp-to-main merge, or parallel-lane extension, etc.).

For example, when the stub probability is 0, the processor 130 may determine that the stub is a road on which the autonomous vehicle 10 cannot travel or a merge route (e.g., maintenance-only lane, shoulder access, or merge-only stub, etc.). In this case, the processor 130 may first arrange lanes of the stub of the merge route and generate the remaining lanes of the main segment. Conversely, when the stub probability exceeds 0 and falls within a range of a specific reference value (e.g., less than 70), the processor may determine that the stub is a branch route (e.g., exit ramp, service-road connector, or optional bypass lane, etc.). In this case, the processor 130 may first arrange the lane of the main segment and arrange the lane of the stub to be connected to the next segment. The processor 130 may configure the lane unit information generated in this way into lane-level map information usable by the autonomous vehicle 10 for traveling (e.g., for path planning, lane keeping, or autonomous lane changing, etc.).

The processor 130 may estimate lane-to-lane connectivity information using the generated lane-level map information (S240).

Specifically, the processor 130 may use the lane-level map information to determine a connectable route between a lane on which the autonomous vehicle 10 is currently traveling and a lane of the next segment (e.g., determining a continuous driving route, merging path, or exit transition, etc.).

The processor 130 may generate a grid map in a grid format based on the lane-level map information. The generated grid map may be composed of grid cells representing each lane and represent connectivity between travelable lanes of the vehicle through the proximity and positional relationships between the cells (e.g., adjacency, overlap, or cross-point relations, etc.).

Specifically, the processor 130 may represent the main segment lane and branch or merge route (stub) lanes within each segment as grid cells and determine the relative positions and the presence of drivable connections between these cells to generate connectivity information (e.g., lane adjacency matrix, connectivity graph, or transition table, etc.).

For example, the processor 130 may search for a lane route from a current lane position of the autonomous vehicle 10 to the destination and form a connected route using lanes on which the vehicle may travel in the future (e.g., optimal merging path, minimal-lane-change path, or shortest-time route, etc.).

In addition, the processor 130 may use the retrieved connectivity information to generate connectivity data for use in driving determination, such as determining whether a lane change is necessary in the future and an optimal lane (e.g., predicting lane-blockage conditions, selecting a high-speed lane, or avoiding congestion, etc.).

Based on the determined lane-to-lane connectivity information, the processor 130 may provide driving information to the autonomous vehicle 10 or control the traveling of the autonomous vehicle 10 (S250).

Specifically, the processor 130 may use the connectivity information to determine a target lane required for the autonomous vehicle 10 to reach the destination (e.g., choosing a through lane, exit lane, or HOV lane, etc.). The processor 130 may determine whether the vehicle is already positioned on the target lane based on the current position of the vehicle and the lane where the vehicle is currently traveling.

When the autonomous vehicle 10 is positioned on the target lane, the processor 130 may control the traveling of the vehicle by outputting a signal to maintain the current lane (e.g., issuing lane-keeping control, steering-angle maintenance, or adaptive speed control, etc.). Conversely, when the autonomous vehicle 10 is not positioned on the target lane, the processor 130 may output a target lane number and the remaining distance to move to the target lane or display the target lane number and the remaining distance on a vehicle display to provide traveling information (e.g., showing “change to lane 2 in 150 m,” “prepare to merge right,” or “stay in current lane,” etc.).

For example, when it is determined that the vehicle is not positioned on the target lane at a branching point, the processor 130 may provide a lane change instruction to move to the target lane and control a driving unit 160 of the vehicle to perform a lane change operation (e.g., automatic steering, differential braking, or torque vectoring, etc.). In this case, information such as the remaining distance to move to the target lane, a lane change time point, and the like may be visually provided to the driver through the vehicle display (e.g., HUD indicator, dashboard prompt, or AR-based guidance line, etc.).

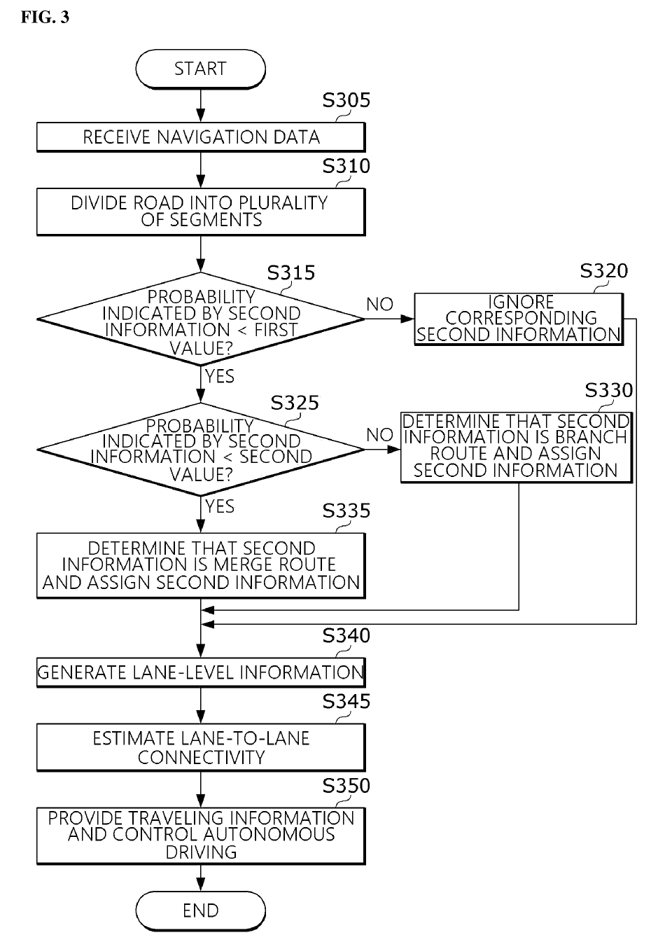

FIG. 3 is an exemplary flowchart for describing the generation of the map using the navigation information in detail according to the example of the present disclosure.

The processor 130 may receive the navigation data through the communication unit 110 (S305).

The processor 130 may receive navigation data from an external navigation server, road management infrastructure server, or cloud through the communication unit 110 (S305) (e.g., V2X infrastructure, high-definition map provider, or real-time traffic data server, etc.).

Specifically, the processor 130 may receive the navigation data including the first information indicating the structure and shape of a road and the second information indicating the probability of the presence of a stub route from an external server periodically or in real time and store the navigation data in the storage unit 120 (e.g., periodic updates every minute, on-demand updates near interchanges, or live streaming in dense-traffic areas, etc.). Since the description of the processing of the received navigation data overlaps that of operation S210 of FIG. 2, the detailed description thereof will be omitted.

The processor 130 may divide the road included in the first information among the received navigation data into a plurality of segments (S310).

Specifically, the processor 130 may set segments as logical units for managing the road and divide the road into a plurality of segments based on the road structure and vehicle traveling environment (e.g., highway vs. local road, tunnel section, or urban intersection, etc.). The processor 130 may perform the segment division based on the entry point and exit point included in the first information (e.g., on-ramp, off-ramp, or rest-area entry, etc.).

For example, the processor 130 may define one segment as a section from a specific entry point to the nearest exit point of the road. In addition, the processor 130 may divide the road into segments using additional criteria, such as points at which the shape of the road or the number of lanes changes abruptly and the like (e.g., curvature exceeding a threshold, steep slope, or lane drop, etc.).

When performing segment division, the processor 130 may assign attribute information, such as the number of lanes, the lane number, the coordinates of the start and end points of the segment, and the like, which are included in each segment (e.g., segment ID, length, lane count, and coordinate pairs, etc.).

In addition, the processor 130 may also include an attribute indicating whether the segment is a main segment or a section connected to an entry/exit (stub) in the segment information (e.g., “Main,” “Merge,” “Branch,” or “Auxiliary” flag, etc.).

The processor 130 may determine whether the probability of the stub route included in the second information of the navigation data is a preset first value or less (S315).

Specifically, the processor 130 may compare the probability value of the stub route with the specific reference value (the first value) to determine whether the probability value is the first value or less (e.g., 50%, 60%, or 70%, depending on road-type calibration, etc.).

Here, the preset first value may correspond to the main segment and may be used as a threshold value to determine a route along which the vehicle may normally travel. For example, the first value may be set to 70, and when the probability value exceeds 70%, it is determined that the stub belongs to the main segment, and the stub may be ignored in subsequent operations (e.g., through-lane continuation without branch processing, etc.).

Conversely, when the probability value is less than 70%, the corresponding stub does not belong to the main segment and may require additional determination as a merging or branch route requiring special attention from the vehicle (e.g., temporary access road, ramp connection, or diverging slip lane, etc.). The processor 130 may initially distinguish the characteristics of the stub through operation S315 and perform a filtering function for subsequent branching or merge route determining and assignment operations.

When it is determined that the probability indicated by the second information is not the first value or less, the processor 130 may ignore the corresponding second information (S320).

Specifically, as the determination result of the previous operation S315, when the stub probability indicated by the second information is a first reference value (e.g., 50%), the processor 130 may consider the corresponding stub to belong to the main segment and ignore the stub (e.g., continue lane continuity logic without adding branch attributes, etc.). In this case, the processor 130 may no longer treat the corresponding stub route as a separate branching or merge route and exclude the stub route from subsequent lane-level information generating or lane-to-lane connectivity determining operations (e.g., exclude it from the connectivity matrix or adjacency graph, etc.).

When it is determined that the probability indicated by the second information is less than or equal to the first reference value, the processor 130 may determine whether the probability indicated by the second information is greater than or equal to a second reference value or more (S325).

Specifically, the processor 130 may compare the probability value of the stub route with the second reference value (the second reference value) to determine whether the probability value is less than the second reference value. The second reference value may be set as a threshold value for determining stubs that are unlikely to be used as the merge route by the vehicle (e.g., low-probability merge paths, disused ramps, or restricted maintenance lanes, etc.).

For example, when the second reference value is set to 20%, it may be determined that a stub route with a stub probability of 0 is a merge route (e.g., a lane merging into the main road with no outgoing traffic, a taper merge, or a shoulder blend, etc.).

On the other hand, when the stub probability is more than the second reference value (e.g., greater than 20% or 30%), it may be determined that the corresponding stub route is a branch route along which a vehicle may travel with a predetermined probability (e.g., optional exit ramp, service road connector, or diverging slip lane, etc.).

When it is determined that the probability indicated by the second information is the second reference value or more, the processor 130 may determine that the second information is a branch route and assign the second information to the corresponding segment (S330).

Specifically, when the probability of the stub route is more than the second reference value (e.g., 20%) and less than the first reference value (e.g., 50%), the processor 130 may consider the corresponding stub as a branch route along which a vehicle may travel with a predetermined probability (e.g., secondary lane for optional detours, highway exits, or side connectors, etc.). The stub route determined to be a branch route may be used as a route along which a vehicle may exit from the main segment in a different direction (e.g., diverging to an outer lane or ramp segment, etc.).

For example, when the stub route with a stub probability of 30% is located at the left side of the main segment, the processor 130 may additionally generate a branch lane at the left side of the main segment (e.g., lane connecting to a bypass or frontage road, etc.). Thereafter, the processor 130 may use the branch lane to determine connectivity to the next segment and set the branch lane as a selectable branch route for the vehicle to move to the target point (e.g., by generating a lane-to-lane connection table or map layer entry, etc.).

When it is determined that the probability indicated by the second information is the second reference value or less, the processor 130 may determine that the second information is a merge route and assign the second information to the corresponding segment (S335).

When the probability of the stub route is the preset second reference value (e.g., 20%) or less, the processor 130 may determine that the corresponding stub route is a merge-only route along which a vehicle cannot directly travel (e.g., on-ramp used by incoming traffic, merging taper, or auxiliary acceleration lane, etc.). The processor 130 may assign the stub route determined to be a merge route to the segment being currently processed, which may then be used when generating lane-level information. The merge route is a separate lane used by external vehicles entering the main segment, and the autonomous vehicle 10 does not directly select and travel along this route (e.g., such as traffic entering from a highway ramp or adjacent feeder lane, etc.), which may be used to prepare for the merging behavior of nearby vehicles while traveling.

For example, when the stub route with a stub probability of 0 is located to the right side of the main segment, the processor 130 may additionally generate a merge-only lane at the right side of the main segment (e.g., simulating the presence of merging traffic from a feeder ramp or access road, etc.). In this case, the processor 130 may combine merge lane information with the main segment to construct connectivity information for the next segment (e.g., establishing adjacency between the merge and main lanes in the connectivity matrix, etc.). Accordingly, the processor 130 may provide the autonomous vehicle 10 with connectivity information for appropriate lane maintenance or lane change determination in subsequent operations in consideration of traffic conditions that may arise due to a merging vehicle (e.g., slowing, yielding, or lateral offset adjustment, etc.).

The processor 130 may use the previously determined and assigned stub route information to generate lane-level information (S340).

Specifically, the processor 130 may generate lane-level map information based on the main segment lane information assigned to each segment and the probability and positional relationship of the stub route (e.g., left/right position, entry angle, or expected merging distance, etc.).

Specifically, the processor 130 may determine whether a stub is located at the left or right side of the main segment and then determine the number and arrangement order of lanes for each segment in combination of the stub probability and positional relationship (e.g., generating lane arrays ordered by left-to-right indexing, etc.).

For example, when the stub probability is 30 and the stub is located at the left side of the main segment, the processor 130 may first generate the lane of the corresponding stub at the left side and then generate the lane of the main segment (e.g., producing a left-branch lane followed by main-lane continuation, etc.). In this case, by first arranging the lane of the stub and then the remaining lanes of the main segment, connectivity with the next segment may be specified (e.g., defining transition pairs between the branch lane and the subsequent lane segment, etc.).

In addition, when the stub probability is 0 and the stub is located at the right side of the main lane, the processor 130 may first arrange a merge lane (lane of the stub) at the right side and then generate the remaining lanes of the main segment (e.g., representing the merging lane geometry or priority rules, etc.). Then, the processor 130 may set lane information to be naturally connected to the next segment through the merge lane (e.g., smooth curvature matching or weighted connectivity scoring, etc.).

The lane-level map information generated in this manner may be used by the processor 130 as basic data for determining lane connectivity and controlling the traveling of the autonomous vehicle 10 (e.g., determining drivable paths, predicting merge conflicts, or adjusting lateral position, etc.). Since more detailed description of the generation of lane-level information overlaps that of operation S230 of FIG. 2, the detailed description thereof will be omitted.

The processor 130 may estimate lane-to-lane connectivity information based on the generated lane-level map information (S345).

Specifically, the processor 130 may represent the lane-level information for each segment as a grid map in a grid format (e.g., a two-dimensional array or matrix representing lanes as cells, etc.). The processor 130 may represent each lane as an individual cell in the generated grid map and determine connectivity between lanes on which the vehicle may actually travel using the proximity and relative positions between the cells (e.g., adjacency, overlap, or intersection between adjacent lane cells, etc.). In particular, the processor 130 may analyze how a branch or merge lane is connected to the lane of the main segment to determine a possible lane change route (e.g., connecting an off-ramp lane, side connector, or merge taper, etc.).

For example, in order to indicate connectivity from a specific lane of the main segment to a branch route, the processor 130 may define a connection route from a cell of the corresponding lane of the main segment to a cell of an adjacent branch lane (e.g., from main-lane cell [2,3] to branch-lane cell [3,4], etc.). In addition, at a position where a merge lane enters the main segment, the processor 130 may define a connection route between the corresponding cell of the lane of the main segment and the cell of the merge lane to represent connectivity (e.g., defining one-way directional connectivity from merge lane to main lane, etc.). Based on the lane-to-lane connectivity determined in this way, the processor 130 may construct an optimal lane change route required for the autonomous vehicle 10 to travel toward its destination (e.g., minimal-lane-change route, shortest travel time, or lowest merge risk, etc.).

Since more detailed description of the lane-to-lane connectivity determination performed in this operation overlaps that of operation S240 of FIG. 2, the detailed description thereof will be omitted.

Based on the determined lane-to-lane connectivity information, the processor 130 may provide driving information to the autonomous vehicle 10 or control the traveling of the autonomous vehicle 10 (S350).

Specifically, the processor 130 may determine an optimal traveling lane (target lane) for reaching the destination based on the current position and traveling lane information of the autonomous vehicle 10 (e.g., selecting an exit lane, avoiding congested lanes, or maintaining an HOV lane, etc.). The processor 130 may determine whether the vehicle is already traveling on the target lane, and based on the result, may maintain the traveling state of the vehicle or generate a control command for lane changes.

For example, when the lane in which the vehicle is currently traveling is the same as the target lane, the processor 130 may output a signal to the driving unit 160 of the vehicle so as to maintain the lane and control the vehicle to maintain the traveling state (e.g., activating lane-keeping assist or adaptive cruise control, etc.). On the other hand, when the vehicle is positioned on a lane other than the target lane, the processor 130 may provide information for changing to the target lane (e.g., issuing “prepare to merge right” or “change to lane 3 in 150 m,” etc.). This information may be transmitted to the driver via the display of the vehicle in the form of indicating the target lane number, the remaining distance to the lane change point, the lane change time point, or visual indicators such as lane arrows or color-coded highlights, etc. In addition, the processor 130 may directly output a command signal to the driving unit 160 to perform lateral control (lane change control) so that the autonomous vehicle 10 may move to the target lane (e.g., by adjusting steering angle, yaw rate, or differential torque, etc.).

Since the detailed description of the provision of traveling information or autonomous driving control performed in this operation overlaps that of operation S250 of FIG. 2, the detailed description thereof will be omitted.

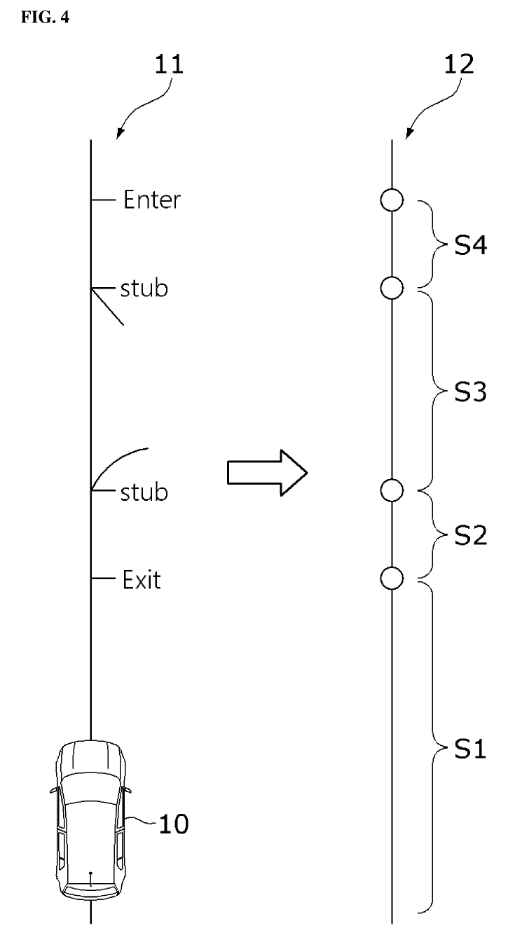

FIG. 4 is an exemplary view showing a process of dividing a road into a plurality of units of segments using navigation data according to an example of the present disclosure.

Navigation data 11 of FIG. 4 shows the entire road section, with the vehicle 10 traveling on the road and a section in which the vehicle 10 may enter or exit in a specific section being present. In addition, two stub routes capable of branching or merging are connected to the right side of the road (e.g., on-ramps, off-ramps, or side connectors, etc.). The stub route represents a route that branches off from the main segment of the road to the outside or merges with the main segment from the outside, and the stub route is provided together with probability information based on each driving possibility (e.g., probability of being used as a drivable route under traffic conditions, etc.). In this example, the stub routes are used as additional information for generating a lane-level map based on the probability of each stub.

FIG. 4 shows a result 12 of the processor 130 dividing the road into a plurality of segments S1, S2, S3, and S4 based on navigation data 11 that has not yet been divided into segments.

Specifically, the processor 130 may divide the road into segments based on the main entry and exit points of the road and connecting points of the stub route (e.g., interchanges, merging zones, or highway junctions, etc.). For example, a road section from a departure point of the vehicle 10 to a point at which the exit point is connected may be defined as a first segment S1, and a section from the exit point to a point at which a first stub is connected may be defined as a second segment S2. Likewise, the processor 130 may define a section from a first stub point to a second stub point as a third segment S3, and a section from the second stub point to the entry point Enter of the road as a fourth segment S4 (e.g., corresponding to consecutive highway blocks or logical route partitions, etc.).

Through such segment division, the processor 130 may assign probability information of the stub to each segment and then generate independent lane-level information for each segment (e.g., lane count, alignment, and connectivity data, etc.), which may be used for determining lane-to-lane connectivity of the vehicle 10 and efficient traveling route planning of the autonomous vehicle (e.g., computing feasible path graphs, optimizing driving routes, or pre-planning lane changes, etc.).

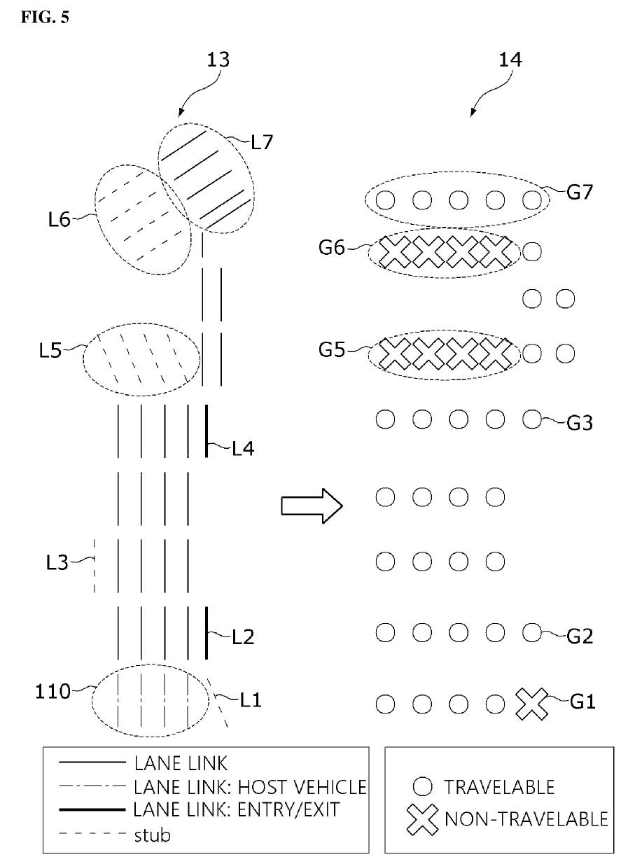

FIG. 5 shows an example of the generation of lane-level information.

FIG. 5 is a view showing an example of generating lane-level information using navigation data and based on this, generating a grid map for connectivity determination according to an example of the present disclosure.

A lane link 13 shown at the left side of FIG. 5 represents information on an individual lane on which an autonomous vehicle may travel (e.g., each link representing a distinct physical or logical lane section, etc.). The lane links include a main segment lane on which a host vehicle is currently traveling, stub lane links L1, L3, L5, and L6 that branch or merge from the main segment to the left or right side (e.g., off-ramp, on-ramp, or side connector, etc.), entry/exit lane links L2 and L4 that allow entry or exit the road, and a main segment lane link L7. The lane links are categorized based on the characteristics and layout of each lane to specifically describe a traveling environment of the vehicle (e.g., number of lanes, direction of flow, or entry/exit type, etc.

A host vehicle lane link represents the lane on the main segment on which the vehicle is currently traveling and serves as a traveling reference of the vehicle (e.g., for positioning, trajectory prediction, or control reference, etc.). The stub lane links L1, L3, L5, and L6 represent lanes on which the vehicle exits from the main segment to another road or merges from another road onto the main segment (e.g., highway merging lanes, service-road entries, or auxiliary connectors, etc.). Entry/exit lane links L2 and L4 are lanes in a section in which the vehicle exits from the main segment to a specific area or enters the main segment from the specific area (e.g., rest area, parking access, or toll plaza lane, etc.), and the main segment lane link L7 is a lane of the main road on which the vehicle normally travels (e.g., the through lane used for continuous cruising, etc.).

A grid map 14 shown at the right side of FIG. 5 is the result converted to analyze and determine lane-to-lane connectivity based on lane-level lane link information, with each lane link being represented by corresponding grid cells G1 to G7 (e.g., one cell per lane with spatial adjacency used to indicate connectivity, etc.). The grid map is a grid-like arrangement of the positions and relationships of each lane to determine connectivity between the lane on which an autonomous vehicle currently travels and its destination (e.g., for determining feasible lane transitions, merging points, or route continuity, etc.).

The grid cell G1 corresponds to the stub lane link L1 and represents a merge or branch lane that is infrequently traveled by the vehicle (e.g., low-probability side lane or maintenance connector, etc.). The grid cell G2 corresponds to the entry/exit lane link L2 and represents an entry/exit section in which the vehicle enters or exits the road at a specific point (e.g., entrance ramp, side access, or roundabout feeder, etc.). The grid cell G3 corresponds to the stub lane link L3 and represents a left branch or merge route (e.g., left exit ramp or left-side merging segment, etc.), and the grid cell G4 corresponds to another entry/exit lane link L4 and represents a right entry/exit route (e.g., right-side off-ramp or slip road, etc.).

The grid cells G5 and G6 correspond to the stub lane links L5 and L6, respectively, and represent sections at which another road may merge to or branch off from the main segment for the vehicle (e.g., complex interchange area, cloverleaf loop, or multi-lane merge, etc.). The grid cell G7 corresponding to the main segment lane link L7 is the lane of the main segment, which is primarily used by an autonomous vehicle while normal traveling, and represents a basic traveling route of the vehicle (e.g., continuous cruising path or default driving lane, etc.).

The grid cells marked by empty circles within the grid map represent lanes on which the vehicle may normally travel (e.g., main lanes, through lanes, or active driving paths, etc.), and an “X” represents a lane on which the vehicle cannot directly travel or special circumstances (e.g., a merge or branch point, diverging area, or blocked route, etc.) are present.

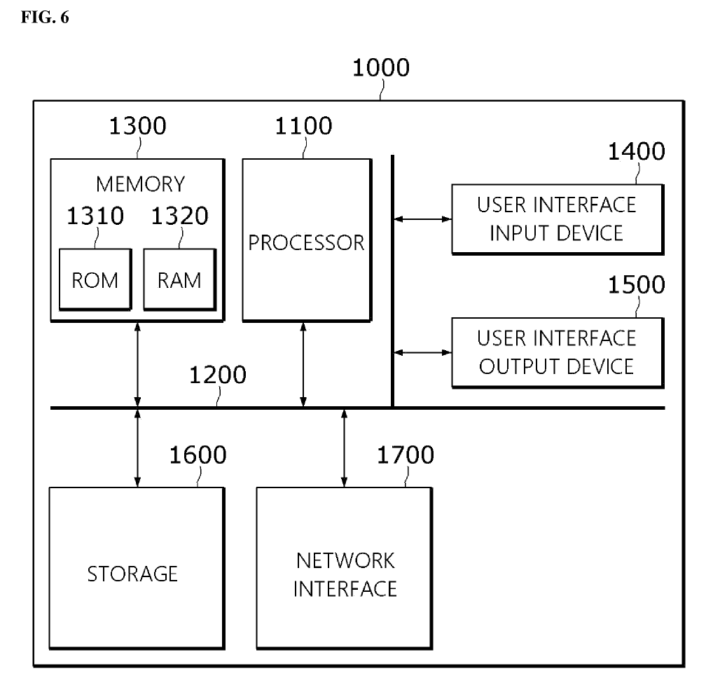

FIG. 6 shows an example computing system (e.g., a computing device of a vehicle or any other apparatus). One or more controllers, processors, etc. described herein, such as one or more components of the vehicle 10 or any other components and devices disclosed herein, may be implemented by or in the computing system as shown in FIG. 6.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

A device for controlling an autonomous vehicle according to an example of the present disclosure may include: a memory in which navigation data is stored; and one or more processors connected to the memory. The navigation data may include first information related to road information and second information indicating a probability of presence of a branch or merge route connected to a specific road section. The one or more processors may be configured to: divide a road included in the first information into one or more segments; assign the second information to the divided segments; generate lane-level map information based on the one or more segments to which the second information is assigned; and control traveling of an autonomous vehicle based on the generated map information.

In some examples of the present disclosure, the one or more processors may be further configured to: determine lane-to-lane connectivity based on the lane-level map information; and provide traveling information or control the traveling of the autonomous vehicle based on the determined lane-to-lane connectivity.

In some examples, the one or more processors may divide the road into the one or more segments based on an entry or exit point included in the first information.

In some examples, the first information may include at least one of a road shape, the number of lanes, an entry point, or an exit point.

In some examples, the one or more processors may generate the lane-level map information based on the probability indicated by the second information and a position of a route corresponding to the second information.

Additionally, the one or more processors may generate the number of lanes to be included in the map information based on the probability indicated by the second information and a positional relationship.

In some examples, the one or more processors may be configured to: assign the second information to the divided segments when the probability indicated by the second information is less than a preset first reference value; and not assign the second information to the divided segments when the probability indicated by the second information is the first reference value or more.

In the device according to some examples, the one or more processors may be further configured to: determine that a route corresponding to the second information is the merge route when the probability indicated by the second information is less than a second reference value that is set to be less than the first reference value; and determine that the route corresponding to the second information is the branch route when the probability indicated by the second information is the second reference value or more.

Furthermore, the one or more processors may generate road-level information based on a current position and traveling direction of the autonomous vehicle in the segments of the road and generate the lane-level map information based on the road-level information.

In some examples, the one or more processors may display the map information on a display of the autonomous vehicle.

A method of controlling an autonomous vehicle according to an example of the present disclosure may include: receiving navigation data including first information related to road information and second information indicating a probability of presence of a branch or merge route connected to a specific road section; dividing a road included in the first information into one or more segments; assigning the second information to the divided segments; generating lane-level map information based on the one or more segments to which the second information is assigned; and controlling traveling of an autonomous vehicle based on the generated map information.

The method according to some examples may further include: determining lane-to-lane connectivity based on the lane-level map information; and providing traveling information or controlling the traveling of the autonomous vehicle based on the determined lane-to-lane connectivity.

In some examples, the dividing of the road into the one or more segments may be performed based on an entry or exit point included in the first information.

In some examples, the first information may include at least one of a road shape, the number of lanes, an entry point, or an exit point.

In some examples, the generating of the lane-level map information may be performed based on the probability indicated by the second information and a position of a route corresponding to the second information.

The generating of the lane-level map information may include determining the number of lanes to be included in the map information based on the probability indicated by the second information and a positional relationship.

In some examples, the assigning of the second information to the divided segments may include: assigning the second information to the divided segments when the probability indicated by the second information is less than a preset first reference value; and not assigning the second information to the divided segments when the probability indicated by the second information is the first reference value or more.

The method according to some examples may further include: determining that a route corresponding to the second information is the merge route when the probability indicated by the second information is less than a second reference value that is set to be less than the first reference value; and determining that the route corresponding to the second information is the branch route when the probability indicated by the second information is the second reference value or more.

In some examples, the generating of the lane-level map information may include generating road-level information based on a current position and traveling direction of the autonomous vehicle in the segments of the road, and generating the lane-level map information based on the generated road-level information.

The method may further include displaying the generated lane-level map information on a display of the autonomous vehicle.

According to the examples of the present disclosure, the processor may use the grid map generated as described above to determine connectivity between traveling lanes of the vehicle, determine the optimal driving lane to the destination, and provide information for autonomous driving control of the vehicle or driver guidance.

According to examples of the present disclosure, by generating a local map based on road shape and lane connectivity information using navigation information, it is possible to efficiently determine a driving lane of an autonomous vehicle and whether a lane change is necessary to reach a destination.

Effects of the present disclosure are not limited to the above effects, and other effects that are not described will be able to be clearly understood by those skilled in the art based on the following description.

While the present disclosure has been described above with reference to preferred examples thereof, it will be understood by those skilled in the art that the present disclosure may be variously modified and changed without departing from the spirit and scope of the present disclosure as set forth in the claims that follow.

What is claimed is:

1. An apparatus of a vehicle, the apparatus comprising:
a memory configured to store navigation data associated with the vehicle, wherein the navigation data comprises:
first information related to road information of a road on which the vehicle is traveling, and
second information indicating a probability of presence of a branch route or a merge route, wherein the branch route or the merge route is connected to a specific road section of the road; and
a processor circuit coupled to the memory and configured to:
divide, based on the first information, the road into a plurality of segments,
assign the second information to the divided plurality of segments,
output, based on the assignment of the second information, a signal indicating lane-level map information, and
control, based on the signal, autonomous driving of the vehicle.

2. The apparatus of claim 1, wherein the processor circuit is configured to:
determine, based on the lane-level map information, lane-to-lane connectivity; and
based on the determined lane-to-lane connectivity, perform at least one of providing traveling information or controlling autonomous driving of the vehicle.

3. The apparatus of claim 1, wherein the processor circuit is configured to divide, based on an entry point included in the first information or an exit point included in the first information, the road into the plurality of segments.

4. The apparatus of claim 1, wherein the first information comprises at least one of a road shape of the road, a number of lanes on the road, an entry point of the road, or an exit point of the road.

5. The apparatus of claim 1, wherein the processor circuit is configured to, based on the probability of presence of the branch route or the merge route and a position of a route corresponding to the second information relative to a main lane of the road, generate the lane-level map information.

6. The apparatus of claim 1, wherein the processor circuit is configured to determine, based on the probability of presence of the branch route or the merge route and a positional relationship between a main lane of the road and one of the branch route or the merge route, a number of lanes to be included in the lane-level map information.

7. The apparatus of claim 1, wherein the processor circuit is configured to:
assign the second information to the divided plurality of segments based on the probability of presence of the branch route or the merge route being less than a preset first reference value; and
not assign the second information to the divided plurality of segments based on the probability of presence of the branch route or the merge route being greater than or equal to the preset first reference value.

8. The apparatus of claim 7, wherein the processor circuit is configured to:
determine that a route corresponding to the second information is the merge route based on the probability of presence of the branch route or the merge route being less than a second reference value that is less than the preset first reference value; and
determine that the route corresponding to the second information is the branch route based on the probability of presence of the branch route or the merge route being greater than or equal to the second reference value.

9. The apparatus of claim 1, wherein the processor circuit is configured to:
generate road-level information based on a current position and traveling direction of the vehicle in the plurality of segments of the road, and
generate, based on the road-level information, the lane-level map information.

10. The apparatus of claim 1, wherein the processor circuit is configured to display the lane-level map information on a display of the vehicle.

11. A method performed by an apparatus of a vehicle, the method comprising:
receiving, via a communication interface of the vehicle, navigation data comprising:
first information related to road information of a road on which the vehicle is traveling, and
second information indicating a probability of presence of a branch route or a merge route, wherein the branch route or the merge route is connected to a specific road section of the road;
dividing, based on the first information, the road into a plurality of segments;
assigning the second information to the divided plurality of segments;
outputting, based on the assignment of the second information, a signal indicating lane-level map information; and
controlling, based on the signal, autonomous driving of the vehicle.

12. The method of claim 11, further comprising:
determining, based on the lane-level map information, lane-to-lane connectivity; and
based on the determined lane-to-lane connectivity, performing at least one of providing traveling information or controlling autonomous driving of the vehicle.

13. The method of claim 11, wherein the dividing of the road into the plurality of segments is performed based on an entry included in the first information or an exit point included in the first information.

14. The method of claim 11, wherein the first information comprises at least one of a road shape of the road, a number of lanes on the road, an entry point of the road, or an exit point of the road.

15. The method of claim 11, wherein the outputting of the signal comprises generating of the lane-level map information based on the probability of presence of the branch route or the merge route and a position of a route corresponding to the second information relative to a main lane of the road.

16. The method of claim 11, wherein the outputting of the signal comprises determining, based on the probability of presence of the branch route or the merge route and a positional relationship between a main lane of the road and one of the branch route or the merge route, a number of lanes to be included in the lane-level map information.

17. A vehicle comprising:
a sensor configured to provide a current position and heading of the vehicle;
a communication interface configured to receive navigation data comprising:
a first part indicating a structure of a road on which the vehicle is traveling, and
a second part indicating a probability of presence of a branch route or a merge route, wherein the branch route or the merge route is connected to a specific road section of the road;
a driving control circuit configured to control autonomous driving of the vehicle; and
a processor circuit configured to:
generate, based on the current position and heading of the vehicle, road-level coordinates in a coordinate frame relative to the vehicle,
divide, based on the road-level coordinates and the first part of the navigation data, the road into a plurality of segments,
classify, based on the second part of the navigation data, for each segment of the plurality of segments, whether a corresponding route is a main lane of the road, the branch route, or the merge route,
output, based on the classification, a signal indicating lane-to-lane connectivity between adjacent segments of the plurality of segments, and
control, via the driving control circuit and based on the signal, autonomous driving of the vehicle.

18. The vehicle of claim 17, wherein the processor circuit is further configured to:
determine, based on the signal, whether a lane change is required to reach a destination, and
based on the determination of whether the lane change is required, cause the vehicle to maintain or change a lane.

19. The vehicle of claim 17, wherein the processor circuit is configured to perform the classification by comparing the probability of presence of the branch route or the merge route with at least one reference threshold.

20. The vehicle of claim 17, wherein the first part of the navigation data comprises at least one of:
an entry point of the road,
an exit point of the road, or
a number of lanes on the road.
